(19) United States
(12) Patent Application Publication
(10) Pub. No.: US 2007/0083770 A1
(43) Pub. Date: Apr. 12, 2007

(54) System and method for foiling code-injection attacks in a computing device

(75) Inventors: Ray Edward Heasman, Seattle, WA (US); James Webb Baker JR., Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Technology Group Northwest Inc., Seattle, WA (US)

(21) Appl. No.: 11/521,866

(22) Filed: Sep. 15, 2006

Related U.S. Application Data
(60) Provisional application No. 60/718,123, filed on Sep. 17, 2005.

(51) Int. Cl. G06F 12/14

(52) U.S. Cl. 713/190

(57) ABSTRACT

A method and computing device for protecting against code-injection attacks by fetching transformed instructions stored in memory and restoring the transformed instructions prior to their execution by a processor or interpreter is presented. An exemplary computing device is configured to execute a method as described in the following steps, as part of fetching a value from memory, restoring the value according to a context and a restore function if the fetch is for an instruction. Thereafter, the restored information is passed on to the next stage of the processor for execution.

### CROSS-REFERENCE TO RELATED APPLICATION

This application claims the benefit of the filing date of Provisional Patent Application No. 60/718,123, filed Sep. 17, 2005, the subject matter of which is incorporated herein by reference.

### BACKGROUND

One of the main gateways for malicious software (generally referred to as “malware”) to enter and take control of a user's computer is to trick the computer into executing instructions that were not intended as part of the currently executing program. As those skilled in the art will appreciate, to execute an application, both executable instructions and data are loaded into memory. Buffer overrun attacks write malicious instructions into the data areas in memory and trick the computer into executing those instructions as if the data were a legitimate program. There are several ways to trick the computer which usually (but not always) involve corrupting a pointer value in the computer's memory. Some examples of this kind of malware attack include buffer overflow attacks, stack overflow attacks, data-as-instructions attacks, injected code attacks, format string attacks, integer overflow attacks, malicious string attacks, malicious code attacks, heap-smashing attacks, pointer-rewrite attacks, and worms. Of these, the stack overflow technique is likely the most common.

While the above attacks differ slightly, they almost always result in the same thing: a pointer to legitimate executable code is corrupted such that it points to malicious code that was surreptitiously loaded into a data area in memory. With the pointer corrupted, at some point during the normal execution of the program the corrupted pointer is followed and begins executing the malicious code.

As those skilled in the art will appreciate, several ways have been proposed for protecting the stack from being “smashed,” i.e., corrupted or otherwise overrun in order to carry out malicious code, which are extensively described in online information stores and encyclopedias such as Wikipedia. However, these techniques for protecting the system are inherently flawed: they try to protect the program from becoming corrupted, or try to detect corruption before the malicious code is executed, which means that these techniques are either too slow to be practicable or are easily circumventable.

In contrast to the above solutions, a desirable approach in protecting a computer against attacks would be to remove the ability of an attacker to inject executable instructions into the computer system in a form that could then be executed by the processor. By removing the ability to inject properly formed instructions into the computer system, the system is not compromised even when an attacker injects instructions (though not properly formed) and attempts to redirect execution on those instructions.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

According to aspects of the present invention, a method to execute instructions stored in a transformed state in a memory, is presented. The method comprises the following steps. As part of fetching a value from memory, restoring the value according to a context and a restore function if the fetch is for an instruction. Thereafter, the restored value is passed on for execution.

According to additional aspects of the present invention, a method to execute an application on a computing device, is presented. The method comprises the following steps. Loading the application into a memory for execution and selectively transforming the instructions of the loaded application according to a transform function and a context. As a transformed instruction is fetched from the memory for execution, the fetched instruction is restored using a restoration function and the context. Thereafter, restored instruction is passed on to the next stage of the processor for execution.

According to further aspects of the present invention, a computing device for protecting against overrun errors by fetching transformed instructions stored in a memory and restoring the instructions prior to their execution is presented. An exemplary computing device includes a processor and a restoration means. The restoration means is logically located on a data path between the processor's instruction decoder and a memory. The restoration means is configured to, upon the a fetch of a value from the memory, selectively restore the value using a context and a restore function if the fetch is for at least part of an instruction, and pass the restored instruction to the next stage of the processor for execution.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram for illustrating general aspects of the invention with regard to a simple von Neumann architecture computer;

FIG. 2 is a pictorial diagram illustrating components of an exemplary computing device suitable for implementing one or more embodiments of the invention;

FIG. 3 is a pictorial diagram illustrating aspects of loading an application into memory for execution according to one aspect of the invention;

FIG. 4 is a block diagram illustrating an exemplary hardware configuration suitable for decoding and executing encoded instructions according to one aspect of the invention;

FIGS. 5A and 5B illustrate exemplary Output Enable truth tables for showing the output of various hardware components configured according to aspects of the invention;

FIG. 6 is a block diagram illustrating an alternative exemplary hardware configuration suitable for decoding and executing encoded instructions according to one aspect of the present invention;

FIG. 7 a block diagram illustrating an exemplary decode block implementing a XOR decoding functionality and suitable for use in the labyrinth circuitry of FIG. 6;

FIGS. 8A and 8B are block diagrams illustrating exemplary key units suitable for use in the labyrinth circuitry shown in FIGS. 4 and 6;

FIG. 9 is a flow diagram illustrating an exemplary load routine suitable for use by an application loader component when loading an application from storage into memory;

FIG. 10 is a flow diagram illustrating a logical representation of an execution routine suitable for implementation in hardware, such as the circuitry of FIGS. 4 and 6, and

FIG. 11 is a block diagram illustrating an exemplary processor and further illustrating various possible locations where labyrinth circuitry can be logically inserted in order to provide functionality of the present invention.

### DETAILED DESCRIPTION

In order to avoid confusion with regard to the usage of various terms, as used throughout this description, the term “transform” and its conjugations are used to refer to the encoding of instructions from the executable opcodes (that are typically decoded by a processor for execution) to an altered state, i.e., a “transformed” state. Indeed, the term “transform,” and its converse “restore,” are used to distinguish between the decoding that processors, interpreters, and/or virtual machines perform on an instruction/opcode in the typical execution thereof, and the transformation and restoration of the executable instructions to foil the various attacks described above in accordance with the present invention.

In a computing device, the execution of applications by a processor, whether that processor is part of a computer, personal digital assistant (PDA), intelligent appliance, mobile phone, or the like, follows a series of steps. On almost all but the simplest processor-embedded devices, when a process is initiated, a corresponding application is loaded into the computing device's memory. To execute, the processor repeatedly fetches instructions and data from memory, usually one or several bytes at a time. The processor then executes the fetched instructions one or several at a time.

As mentioned above, code injection and similar attacks trick the processor into executing one or more instructions of malicious code by writing the malicious code into the memory's data area, for example by overflowing a buffer. (In this paragraph the word “buffer” is used in a computer science context meaning “memory used to temporarily store data”.) The contents of the overflowed buffer in a code injection attack is a series of executable instructions written in such a way as to cause the computing device to perform the attacker's intended action. For example, the “Code Red” worm used a buffer overflow in a URL parsing function to take control of and infect computers running the Microsoft IIS Web Server. The worm defaced any web sites running on an infected server, and directed all infected servers to launch coordinated denial-of-service attacks on certain well known IP addresses, such as various government web sites. The particular details of the Code Red worm are well known and readily available on various Web sites.

To combat the types of attacks described above, and according to aspects of the present invention, when any application is loaded into memory for execution, the executable instructions of that application are transformed and stored in memory. Moreover, the executable instructions remain in their transformed state as long as they reside in memory. In contrast, the application's data is not transformed and, therefore, is simply placed in memory.

Clearly, transformed executable instructions must be restored to their executable form in order to be executed by the processor. Accordingly, the transformed instructions are restored as part of the fetch process for execution by the processor and remain restored only within the context of being executed by the processor. However, the executable instructions remain transformed in memory.

As those skilled in the art will recognize, the present invention does not address malware's ability to corrupt a return pointer on the stack to point to malicious instructions surreptitiously written into a data area according to the various attacks described above. However, the malicious instructions are placed in memory without being transformed and, thus, when the malicious instructions are fetched, the restoration process renders the instructions ineffective. Of course, attempting to execute the “restored” malicious instructions may result in a program or system crash. However, in almost all instances, a crash is preferable to the malicious results of the malware. Fortunately, some crashes may be averted or quickly detected and handled gracefully by the operating system.

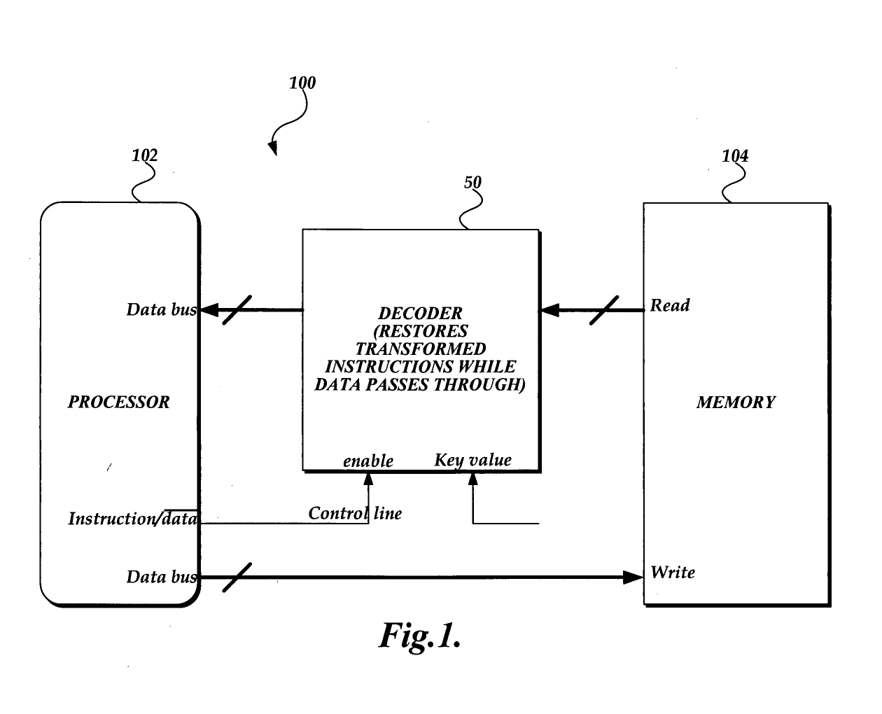

To better set forth the various aspects of the present invention, reference is made to the accompanying drawings. More particularly, FIG. 1 is a block diagram for illustrating general aspects of a simple von Neumann architecture computing device adapted according to aspects of the present invention. As shown in this figure, the computing device 100 includes a processor 102 and a memory 104. While not shown in this figure, the memory stores the loaded application including both transformed instructions and data. As appreciated by those skilled in the art, while in many modern computers memory 104 typically comprises volatile random access memory (RAM), it is anticipated that memory 104 may also comprise ROM (with applications burned therein), programmable ROM (PROM), non-volatile RAM, and the like. In this simplified computing device 100, the processor reads instructions and data over a data bus as they pass through a decoder 50. As mentioned above, the decoder 50 restores transformed instructions read from memory as part of a fetch operation. The decoder 50 knows whether or not the fetched information is data or instruction according to information available from the processor 102, such as a control line indicating whether the fetched information is an instruction or data. Moreover, the decoder restores transformed instructions according to a key value, which may be located within a processor's register or other key value storage location.

As further shown in FIG. 1, the processor 102 writes information back to the memory 104 over the data bus. However, when writing, the decoder 50 is bypassed, at least in a logical sense. Various detailed descriptions regarding a decoder 50 are set forth below.

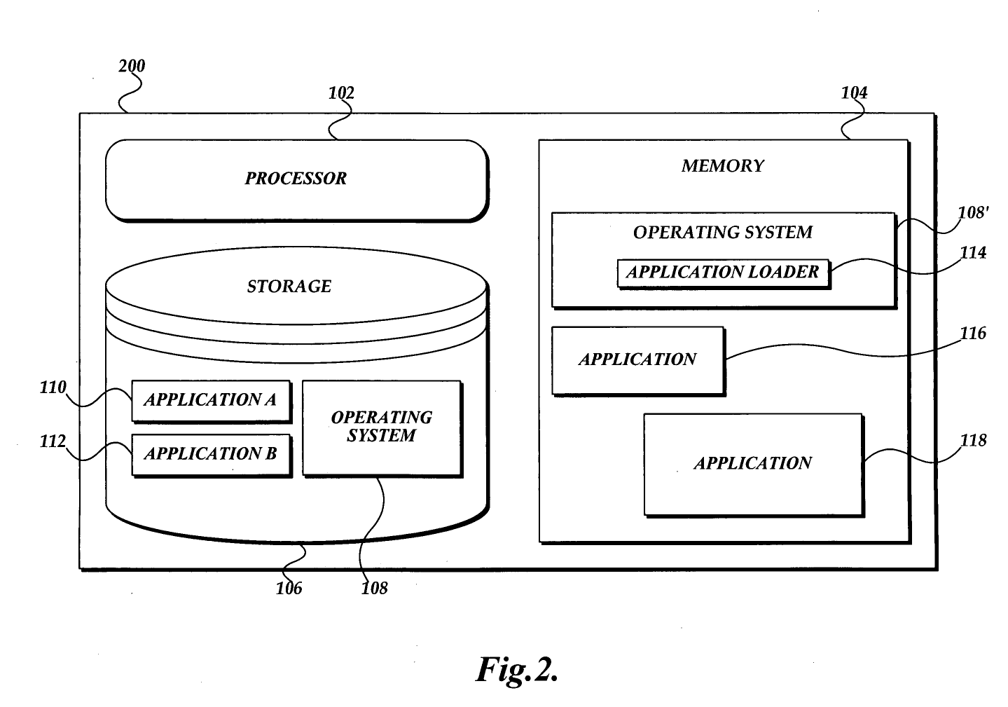

As mentioned above, aspects of the present invention may be implemented on a variety of devices such as, but not limited to, mobile phones, PDAs, mini- and mainframe computers, tablet, notebook, and desktop personal computers, and the like, running nearly any type of processor, including either synchronous or asynchronous processors. However, while there are numerous configurations of computing devices in which the present invention may be implemented, FIG. 2 is a pictorial diagram illustrating components of an exemplary computing device 200 suitable for implementing one or more embodiments of the invention. The exemplary computing device 200 includes a processor 102 and a memory 104. Also illustrated, as part of the exemplary computing device 200, is a storage device 106. As those skilled in the art will appreciate, in many computing devices, the storage device 106 is a non-volatile storage area which can store applications, such as applications 110 and 112, even when the computing device 100 is not powered, whereas the memory 104, as mentioned above, is viewed as a volatile storage area such as random access memory (RAM). Of course, on many devices these typical assumptions (with regard to volatile and non-volatile hardware) are not true, and thus the present configuration should be viewed as illustrative only, and not construed as limiting upon the present invention.

The storage device 106 also typically stores an operating system 108. When the computing device 200 is powered on, the operating system 108 is loaded (as illustrated by operating system 108') and executed as part of an overall computing system. Moreover, the operating system 108 typically includes an application loader 114 which is used to load applications 110-112 from the storage device 106 into memory. Of course, in a computing system 200 adapted according to the present invention, the various executable instructions of the operating system 108 are stored in memory 104 as transformed instructions.

Other items that may be stored on the storage device 106 include an interpreter, virtual machine, or processor emulator (none of which are shown) any of which may be configured according to aspects of the present invention to fetch, decode, and execute executable instructions loaded in memory 104. Of course, while aspects of the present invention may be implemented in an interpretive or emulative environment, in at least one embodiment these same aspects may be implemented in circuitry in or around the processor 102.

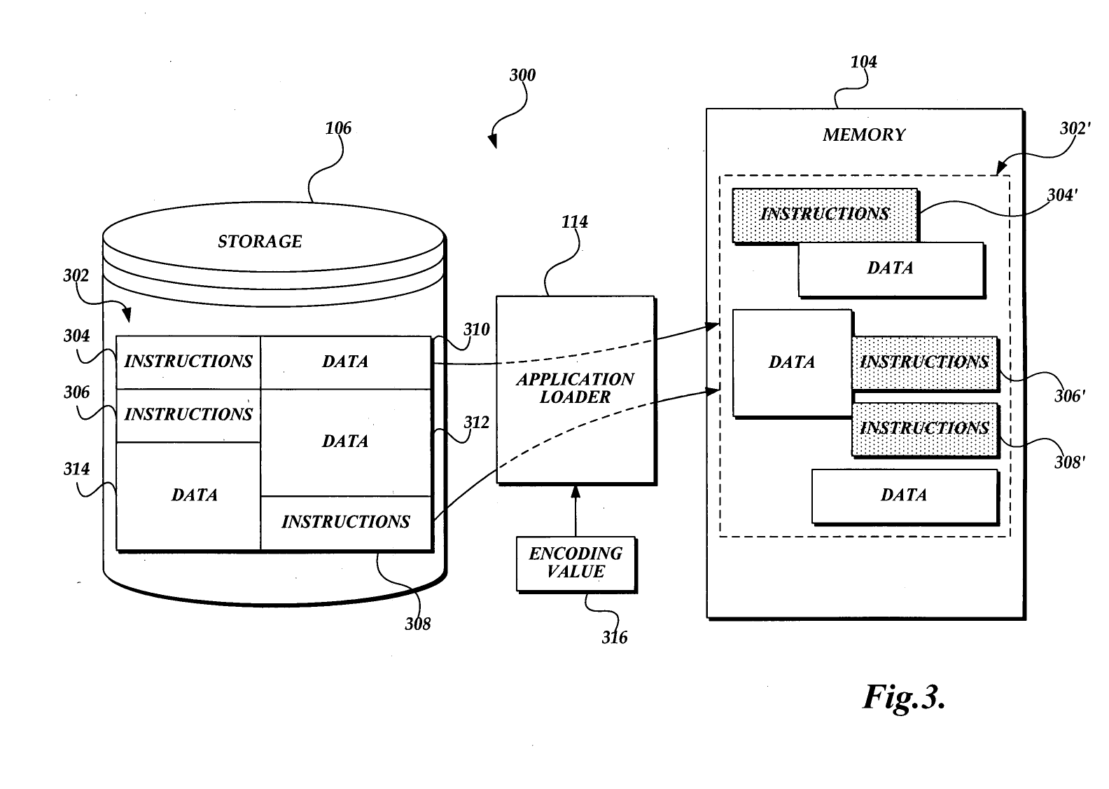

In order to more fully illustrate aspects of the present invention with regard to loading an application, FIG. 3 is a pictorial diagram 300 illustrating aspects of loading an application 302 from storage 106 into memory 104 for execution by a processor 102 (or interpreter) according to aspects of the invention. More particularly, as those skilled in the art will appreciate, an application typically comprises a mix of both executable instructions 304-308 and data 310-314. When the operating system 108 (FIG. 2) operating on a computing device, such as computing device 300, receives an instruction to load an application 302 for execution, the application loader 114 retrieves the application from storage 106 and locates, or stores, the application in memory 104. In addition to simply loading the application into memory, the application loader 114 transforms each instruction of the application using an encoding value 316. Accordingly, as shown in loaded application 302′, instructions 304′-308′ are shaded, indicating that they are transformed.

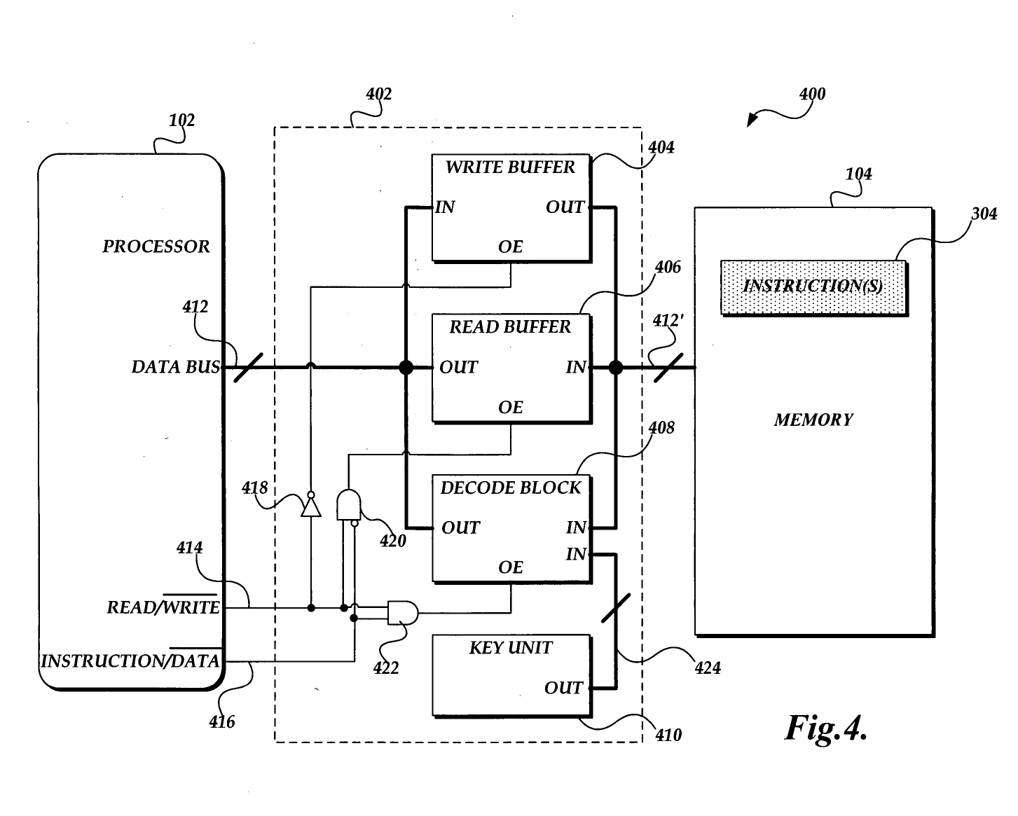

With the application loaded into memory 104, including the executable instructions being transformed, focus can now turn to the fetch and execute the processes. To this end, FIG. 4 is a block diagram illustrating an exemplary hardware configuration 400 suitable for restoring and executing transformed instructions. More particularly, the exemplary configuration 400 includes a processor 102, a memory 104 storing transformed executable instructions 304′, and a decoder 402 (which in this figure is implemented as decoder circuitry and referred to generally as “labyrinth circuitry”) for restoring the transformed executable instructions 304′ for execution by the processor 102.

With regard to the processor 102, the processor is connected to a data bus 412 from which it reads and writes data to and from memory 104. Of course, in the sense of information on the data bus 412, this “data” may include both instructions and data. The processor 102 is also shown as having two output lines: a read/write line 414 and a instruction/data line 416. These lines are binary output lines. The read/write line 414 outputs an indicator as to whether the operation on the data bus 412 is a read operation (i.e., from memory 104 to the processor 102) or a write operation (i.e., from the processor 102 to memory 104). As those skilled in the art will appreciate, the bar above “WRITE” for the read/write line 414 indicates the low (or zero) value is indicative of a write operation on the data bus 412. The code/data line 416 indicates whether the information requested (either read or written) is an instruction or data.

The exemplary labyrinth circuitry 402 includes a write buffer 404, a read buffer 406, a decode block 408, and a key unit 410. (In this and the following paragraphs the term “buffer” is used in the electrical engineering context meaning “an amplifying or isolating logic element”.) Additionally, the exemplary labyrinth circuitry 402 includes an inverter 418 connected to the read/write line 414; an AND gate 420 connected to both the read/write line 414 and the instruction/data line 416 with the instruction/data line inverted; and another AND gate 422 connected to both the read/write line and the instruction/data line. Still further, a key bus 424 connects the key unit 410 to the decode block 408. As can be seen, the write buffer 404, the read buffer 406, and the decode block 408 are each connected to the data bus 412, and placed in such a way such that all information that flows to the processor 102 from memory 104 must pass through the labyrinth circuitry 402.

While each of the write buffer 404, read buffer 406, and decode block 408 (as well as the key unit 410) will be described below, it should be appreciated that according to the illustrated embodiment of FIG. 4, the write buffer, read buffer, and the decode block are tri-state devices. As those skilled in the art will appreciate, when enabled, a tri-state device outputs either a high value (1) or a low value (0), but when disabled, a tri-state device does not output a drive signal. Accordingly, each of the write buffer 404, the read buffer 406, and the decode block 408 include an OE input (for “output enable”) such that if high (1) the tri-state device is enabled and outputs a value (either a high or low value) on the data bus 412, but if low (0) the tri-state device is disabled and does not output any drive signal on the data bus.

In this illustrated embodiment, the key unit 410 is configured to always output a key value over the key bus 424, which key value is used to restore transformed instructions in the decode block 408.

As can be seen, the OE input of the write buffer 404 is connected to the read/write line 414 via the inverter 418. Thus, when the read/write line 414 outputs a low value (0), the inverter 418 inverts the value which enables the write buffer 404. As can be seen, the write buffer is enabled and outputs a value on the data bus 412 when the read/write line 414 is low (0), but is disabled when the read/write line is high (1).

The OE input of the read buffer 406 is connected to both the read/write line 414 and the instruction/data line 416 via an AND gate 420, with the value of the instruction/data line inverted. Thus, when the read/write line 414 is high (1), implying a read from memory 104 to the processor 102, and the instruction/data line 416 is low (0), implying that the requested information is data, the read buffer is enabled and transfers the data on the data bus 412 from memory 104 to the processor 102.

The OE input of the decode block 408 is connected to both the read/write line 414 and the instruction/data line 416 via an AND gate 422. In this configuration, when the read/write line 414 is high (1) and the instruction/data line 416 is also high (1), implying that the requested information is an instruction, the decode block decodes the instruction obtained from memory 104 using the key value on the key bus 424 and outputs the decoded instruction on the data bus 412 to the processor 102.

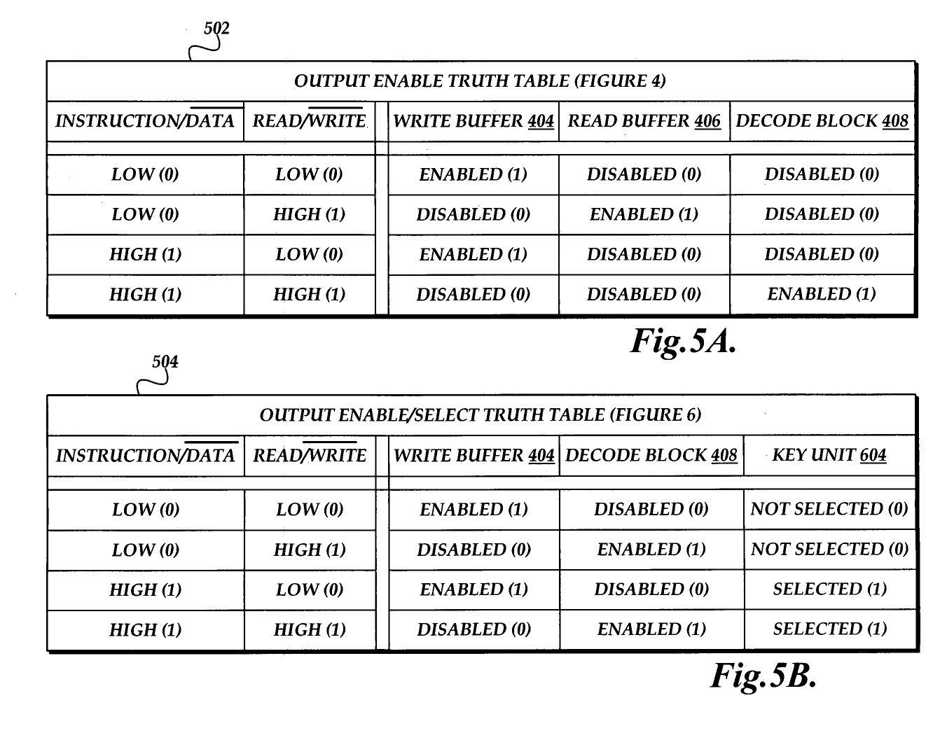

As a simplification of the above enabled/disabled states, FIG. 5A illustrates an exemplary Output Enable truth table 502 for showing the enabled state of the tri-state devices of the labyrinth circuitry 402, i.e., the read buffer 406, the write buffer 404, and the decode block 408, in response to the various outputs of the read/write line 414 and code/data line 416.

With regard to the configuration presented in FIG. 4, and particularly in regard to the labyrinth circuitry 402, while illustrated as being separate from the processor 102, it should be appreciated that the labyrinth circuitry may be incorporated within the processor itself, as part of the core processor (i.e., part of a chip and internal to the processor), or as a supporting circuitry to the processor (i.e., part of the chip but external to the processor core). More generally, the labyrinth circuitry may be added at various points between the processor and memory, including being part of a memory managing subsystem, all of which are anticipated as falling within the scope of the present invention. Moreover, the logic behind the labyrinth circuitry 402, along with other processor functionality may be readily implemented as a drop in module of a processor in a field programmable gate array (FPGA) and/or in an application specific integrated circuit (ASIC) when the processor is a core.

With further regard to the configuration presented in FIG. 4, as well as other configurations presented below, the labyrinth circuitry 402 has been presented in its simplest form for illustration purposes. More particularly, the labyrinth circuitry 402 has been presented as un-clocked, non-interleaved, non-pipelined, and non-multiplexed circuitry. However, as indicated, this is purely for simplicity in illustration and should not be construed as limiting upon the present invention. Those skilled in the art will appreciate that the labyrinth circuitry 402 is readily adapted as clocked, interleaved, pipelined, and/or multiplexed circuitry, and the skill and knowledge to do so, without undue experimentation, is readily available.

It should be appreciated by those skilled in the art that there may be some instructions that span more than one discrete memory such that it requires more than a single fetch, i.e., a “single” instruction may span multiple bytes, or words, etc. Moreover, when this occurs, it may not be necessary to transform the “entire” instruction but only one or more portions. For example, assume that a single instruction is stored in two words, and each word must be fetched separately. It may be sufficient to foil an injection attack if only one of the words was transformed and subsequently restored, assuming also that the labyrinth circuitry was aware as to which word was transformed. This could logically be accomplished by using a key value in the transform and restore functions that represent the identity function. If the restore/transform functions used XOR, a key value of zero would leave a word (i.e., a portion of a multi-fetch instruction) unchanged. However, for purposes of the present discussion, whether all or a part of an instruction (that requires more than one fetch to retrieve) is transformed, it is viewed as the instruction, as a whole, is transformed and subsequently the instruction, as a whole, is restored.

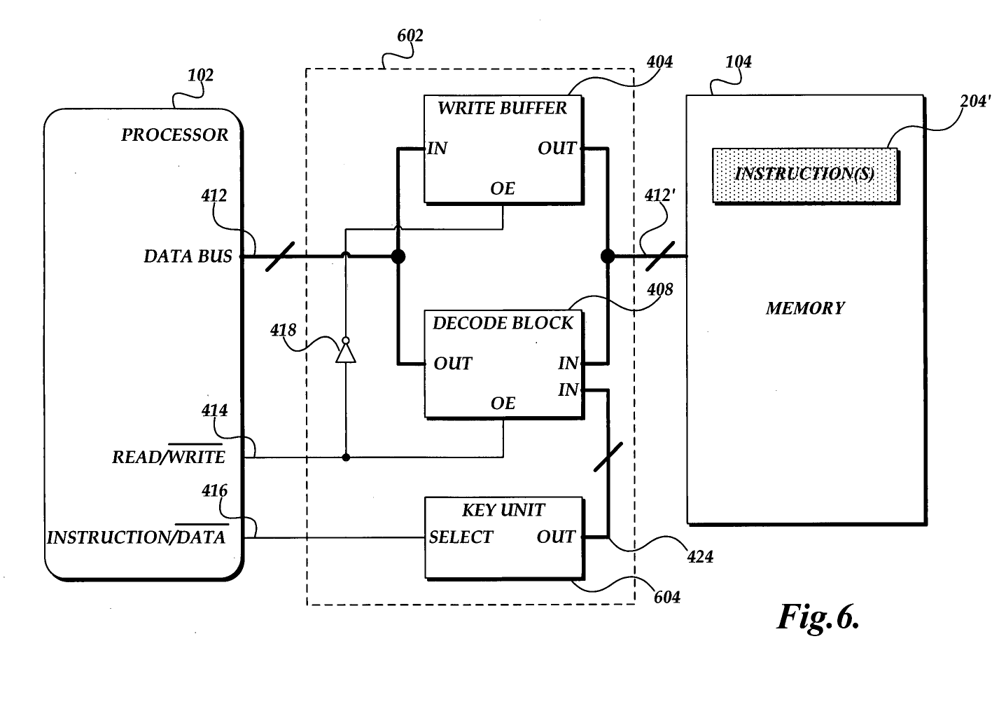

While FIG. 4 presents one embodiment of the labyrinth circuitry 402, those skilled in- the art will appreciate that functionality of the labyrinth circuitry may be configured in a variety of manners, each of which is functionally equivalent with regard to restoring transformed instructions retrieved from memory 104. For example, FIG. 6 is a block diagram illustrating an alternative configuration of the labyrinth circuitry 602 suitable for restoring transformed instructions retrieved from memory 104 for execution by the processor 102. As can be seen, the processor 102 still includes a data bus 412, a read/write line 414, and an instruction/data line 416 as described above in regard to FIG. 4, and the labyrinth circuitry 602 relies upon the read/write line and instruction/data line to determine whether the information on the data bus 412 is being read from or written to memory, and whether the information corresponds to instructions or data.

The labyrinth circuitry 602 includes a write buffer 404 and a decode block 408, both of which are tri-state devices. The labyrinth circuitry 602 further includes a key unit 604, different from the key unit 410 described above in regard to FIG. 4, which is connected to the decode block 408 via a key bus 424. Also included in the labyrinth circuitry 602 is an inverter 418 connected to the read/write line 414.

The write buffer 404 is the same as described above in regard to FIG. 4, including its OE lead being connected to the read/write line 414 via the inverter 418. Thus, the write buffer 404 is enabled and outputs a value on the data bus 412 when the read/write line 414 is low (0), but is disabled when the read/write line is high (1).

The decode buffer 408, itself, is also configured the same as described above in regard to FIG. 4. However, unlike the overall configuration of the labyrinth circuitry 402, the OE lead of decode block 408 in the labyrinth circuitry 602 is connected directly to the read/write line 414, and is therefore enabled whenever the read/write line is high (1) indicating a read. In this embodiment, because all reads from memory 104 to the processor 102 pass through the decode block 408, the restoration process implemented by the decode block must be able to properly process both data and transformed instructions, and relies upon the key value output on the key bus 424 from the key unit 604 to ensure that only transformed instructions are actually restored.

For its part, the key unit 604, not being a tri-state device, always outputs a value on the key bus 424 to the decode block 408. However, the key unit 604 is configured with one or more Select lead(s) connected to the instruction/data line 416, and possibly other context information. In this embodiment, if the select value is high (1), as indicated on the instruction/data line 416, the appropriate key value to restore a transformed instruction is output to the decode block 408. Alternatively, if the select value is low (0) indicative of data, as indicated on the instruction/data line 416, an alternative key value is output such that when combined with data in the decode block 408, the data is unmodified. While there are a variety of means to implement selectively restoring transformed instructions while data remains unchanged, an efficient way to accomplish this is to use a logical XOR (exclusive or) operation as the transform/restore operation. Those skilled in the art know that the XOR operation provides a true “round trip,” i.e., that a value encoded (or transformed) with a key in an XOR operation is properly restored with a subsequent application of the XOR operation using the same key, as defined by the formula, v=XOR( XOR(v, k), k), where v is the value transformed and restored, and k represents a key value used by the XOR operation to transform and subsequently restore v. Moreover, when the select value is low (0) on the instruction/data line 416, indicating that the value read is data, the key unit 604 outputs a zero (0) thereby leaving the data unmodified, since v=XOR(v, 0) or the identity function.

While an XOR operation using a discrete key value is both efficient and effective, a more general mathematical description of the transform/restore operation is found in the formula, v=Restore(Transform(v, c), c), where v is the value to be transformed and restored, Restore represents the restoration function that restores a transformed v, Transform represents the transformation function, and c represent a context which is used by both the restoration function Restore and the transformation function Transform to “round trip” the value v. A context c may simply comprise a key value, but may also include, but not be limited to, one or more process privilege bits, address space numbers, a process identifier (ID), a user's password and/or biometric information, one or more lowest address lines, or any combination thereof. Moreover, when using the general mathematical formula described earlier, an identity context, ic, should also be available such that it satisfies the equation v=Restore(v, ic), and possibly, v=Transform(v, ic). In this manner, if all information—both instructions and data—were “restored” via the labyrinth circuitry (or its functional equivalent), an identity context could be provided when the fetched information corresponds to data.

With regard to a key value used by a key unit 604 or 410 to restore transformed instructions, while a suitable key value may be obtained from a variety of sources, a key value may be generated via a random number generator (or pseudo-random number generator) at boot of the computing device and used as the key value for each process running on the computing device, or in combination with a context for each process such that each process ultimately includes a unique key value. Moreover, a random number may be generated for each process launched on the computing device and used as the key value for the corresponding process, or in combination with the process's context. As an alternative to a random number, or pseudo-random number, a key value may be assigned to a particular computing device and/or processor, or derived from each computing device's serial number. Yet other alternatives include a nonce, a virtual machine ID, a security token, a hard to guess number, or any combination thereof. While not shown, in at least one embodiment, the processor 102 is configured to store one or more key values, irrespective of whether or not the key values are used in combination with a processes context. Alternatively, a software module, such as the application loader 114 or some other component of the operating system 108 may store the various key values corresponding to the executing processes. Still further, it should be appreciated that context switches from one process to another, and/or privilege escalations may require the use of different key values and/or contexts.

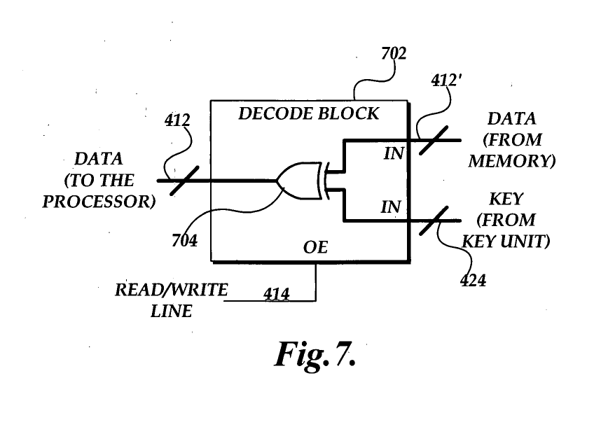

FIG. 7 is a block diagram illustrating an exemplary decode block 702 implementing XOR transform/restore functionality and suitable for use in the labyrinth circuitry 602 of FIG. 6. More particularly, the decode block 702 accepts values (either instructions or data) on the data bus 414 from memory 104 and a key value on the key bus 424 from a key unit 604. Internal to the decode block 702 is an array of XOR gates, represented by the logical XOR symbol 704, which perform an exclusive OR operation on the value on the data bus 412′ (i.e., from memory) with the key value on the key bus 424 and outputs the results on the data bus 412 to the processor 102. However, as the exemplary decoding block 702 is a tri-state device, a value is output to the processor 102 only when the decode block is enabled (i.e., when the read/write line 414 is high (1)).

Returning again to FIG. 6, in order for the decode block 408 to always be able to perform the restore operation, even when the information read from the memory 104 is data, the key unit 604 selectively outputs zero or the key value, depending on the value received at the select lead. This enables the decode block to always “restore” all information read by the processor 102 since, as mentioned above, v=XOR(v, 0). FIG. 5B illustrates the output enabled/select state values of the various components of the labyrinth circuitry 602 of FIG. 6. Of course, with regard to the key unit 604, when not selected (0), the output of the key unit is zero, otherwise the output of the key unit is the key value.

It should be appreciated that while an XOR operation is an efficient and relatively effective means for encoding instructions, the present invention should not be construed as limited to the use of XOR. Any suitable encoding/encryption algorithm may be used for transforming and restoring executable instructions. For example, other transform/restore functions may include, but are not limited to, a substitution box (s-box) technique, a Feistel network, and the like, each of which are well known in the art. Moreover, while symmetrical encoding techniques may be more efficient in storing a single encoding value, both symmetrical and asymmetrical encoding/decoding techniques may be used so long as the equation v=Restore(Transform (v, c), c) is preserved.

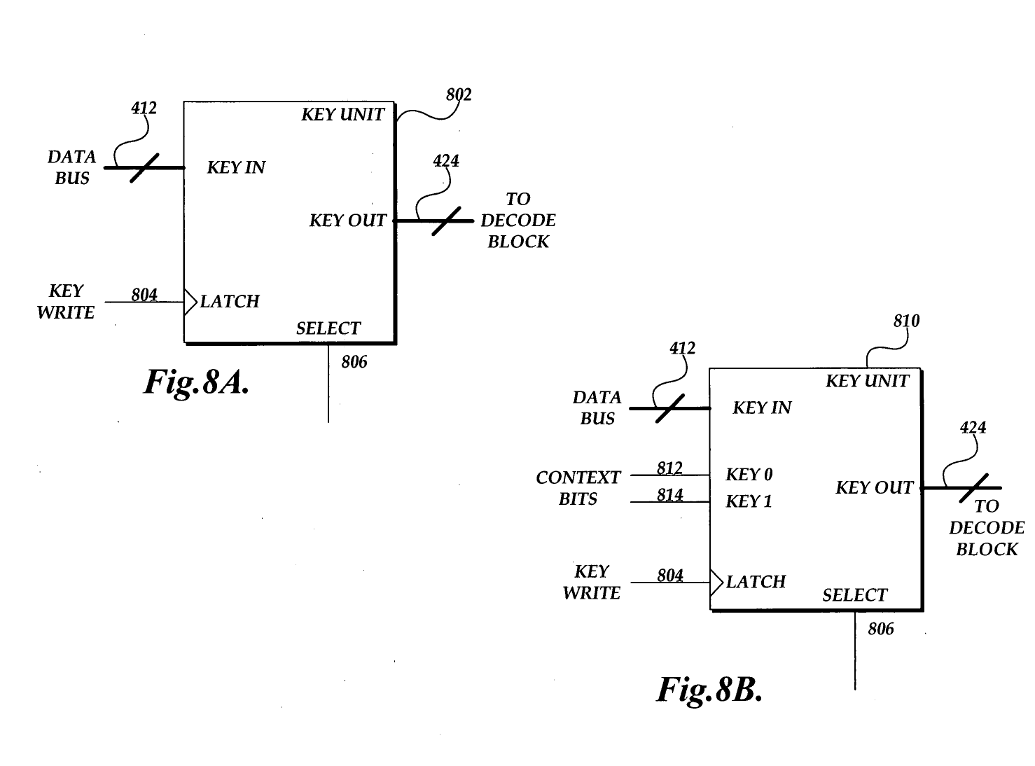

Turning now to FIGS. 8A and 8B, these are block diagrams illustrating exemplary key units suitable for use in the hardware configurations as shown in FIGS. 4 and 6. With regard to FIG. 8A, key unit 802 is connected to key bus 424 on which to output a key value (not shown) or zero (if the select line 806 is low (0)). Of course, since the key value is not a fixed value, the key unit 802 obtains the key value from the data bus 412 when the latch lead goes high (1) from the key write line 804.

To enhance the security of the instructions, multiple key values may be used. In one embodiment, the key value necessary to transform and restore an executable instruction depends upon the storage/memory address of the instruction. More particularly, in one embodiment, the least significant bits of the memory address of a given instruction are used as an index to determine which key value to use in transforming and/or restoring the instruction. Accordingly, the number of key values should correspond to a power of two. FIG. 8B illustrates an exemplary key unit 810 that would utilize and temporarily store four different key values (not shown) corresponding to the different combinations available over the two least significant address bits on lines 812 and 814. As with the key unit 802, the key values are read from the data bus 412 and stored according to the address bits on lines 812 and 814 when the write select lead detects a high (1) on the key write line 804. The select lead determines whether to output zero as the key value when the select 806 is low (0) or output a key value according to the address bits when the select lead is high (1).

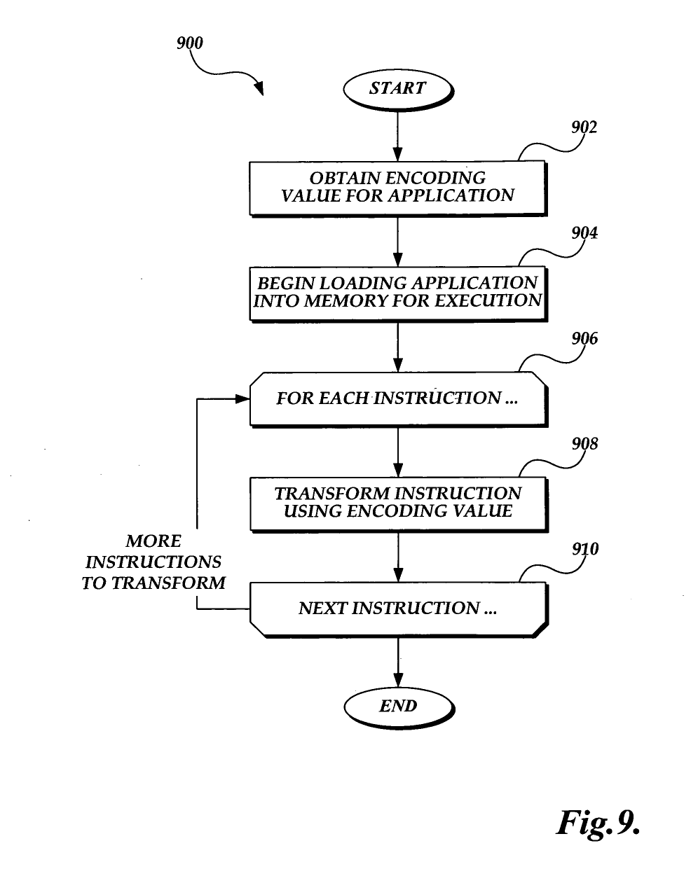

FIG. 9 is a flow diagram illustrating an exemplary load routine 900 suitable for use by an application loader component 114 when loading an application 110 from storage 106 into memory 104. Beginning at block 902, the encoding value 316 is obtained. The encoding value used to transform executable instructions needs to be generated such that attackers cannot guess it easily, and should be changed often, if possible. As described above, the encoding value 316 can be randomly generated, derived from provided information, unique to a device or program, or some combination of the above. At block 904, the application loader 114 starts loading the application 110 into memory 104 for subsequent execution.

At control block 906, a looping process is begun to iterate through each instruction loaded into memory 104 for transformation. At block 908, an instruction is transformed using the obtained encoding/key value according to a predetermined transformation function (such as XOR). If multiple key values are used, the appropriate key value is selected for each instruction and used to transform that instruction, as described above in regard to FIG. 8B. At control block 910, the routine 900 returns to control block 906 if there are additional instructions in memory 104 to be transformed. Otherwise, i.e., all instructions have been transformed, the exemplary routine 900 terminates.

It should be appreciated that on some devices, particularly “simple” devices, applications are pre-loaded by the manufacturer. In these instances, the pre-loaded applications would be written to the device such that the instructions written to the device are already transformed using a predetermined encoding key, such as the device's serial number.

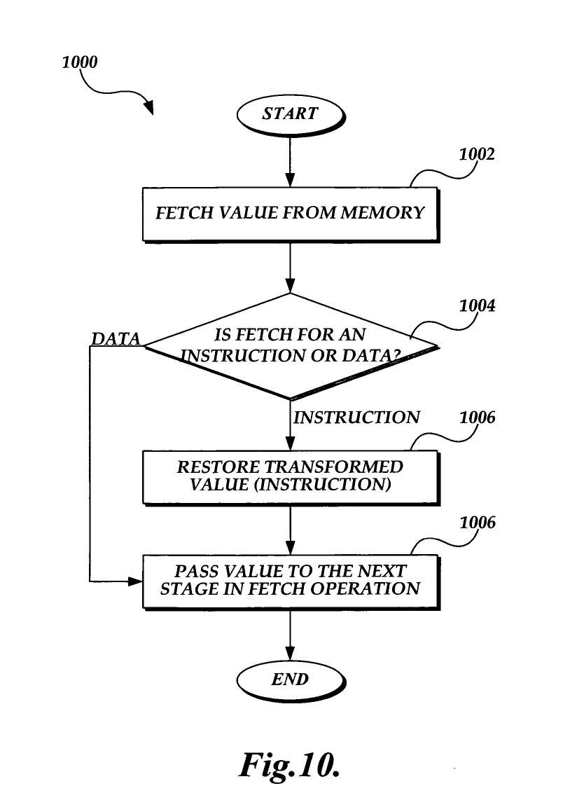

FIG. 10 is a flow diagram illustrating a logical representation of an execution routine 1000 suitable for implementation in hardware, such as the labyrinth circuitry 402 or 602, for executing transformed instructions stored in memory 104. Beginning at block 1002, a value is fetched from memory 104. At decision block 1004, a determination is made as to whether the fetch is for an instruction or for data. Of course, this determination is simply a logical determination, and perhaps not an actual determination, since in several embodiments, as illustrated in FIGS. 4 and 6, the “determination” as to whether the fetch is for an instruction or data is based on the instruction/data signal line 416 which controls one or more gates and devices.

If the fetching operation is for an instruction, at block 1006 the fetched instruction is restored using the restoration function and the corresponding key value. Of course, while not shown, if multiple key values are used, the particular key value to be used must be also determined using the available context, such as one or more of the lowest significant address bits. After restoring the transformed instruction, or if the value was not an instruction but rather data, the value is then passed onto the next stage within the processor 102. Thereafter, the routine 1000 terminates.

With regard to the above described routines, it should be appreciated that these are logical steps and may not correspond to actual discrete steps in their respective processes. Similarly, those skilled in the art will appreciate that the above-described routines may include various steps that are not identified which have been omitted for purpose of clarity in describing more pertinent aspects of the present invention. Moreover, with regard to routine 900, whether the application is first loaded into the memory 104 before the instructions are transformed, or whether the instructions are transformed as they are retrieved from storage 106 and stored in memory 104 is not important, and both are anticipated as falling within the scope of the present invention.

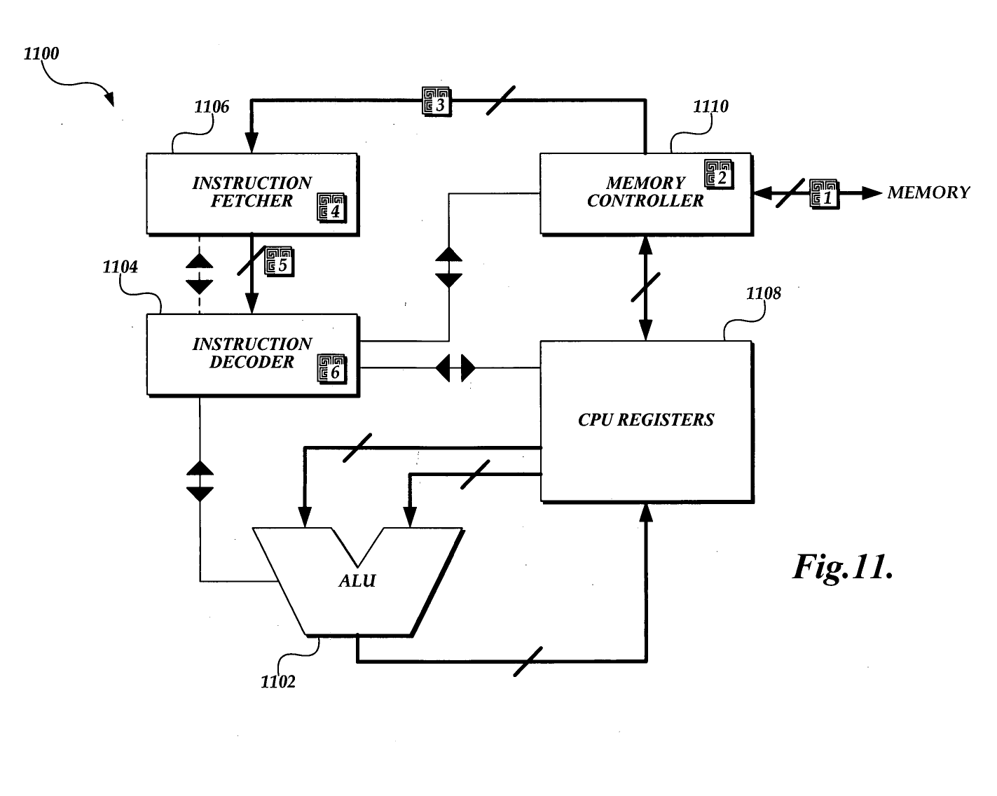

FIG. 11 is a block diagram illustrating an exemplary processor 1100 and further illustrating various possible locations where labyrinth circuitry can be logically inserted in order to provide functionality of the present invention. As shown in FIG. 11, an exemplary processor 1100 includes an arithmetic logic unit (ALU) 1102, an instruction decoder 1104, an instruction fetcher 1106, CPU registers 1108, a memory controller 1110, as well as various data paths and control lines between the various components. The instruction decoder 1104 is not the same as the decode block 408 of the labyrinth circuitry which restores transformed instructions, but rather the typical instruction decoder as found in a typical processor. In other words, a restored instruction must still be decoded by the instruction decoder 1104 in order for the ALU 1102 to perform the corresponding operations.

As can be seen by the numbered icons, the labyrinth circuitry may be located in any number of locations with regard to the processor 1100. Moreover, icon 1 illustrates that the labyrinth circuitry may be placed between the memory and the memory controller 1110. Icon 2 illustrates that the labyrinth circuitry may be located within the memory controller 1110. The labyrinth circuitry may also be placed between the memory controller 1110 and the instruction fetcher 1106, as indicated by icon 3. Still further, the labyrinth circuitry may be placed in either the instruction fetcher 1108 as indicated by icon 4, between the instruction fetcher 1106 and the instruction decoder 1104 as indicated by icon 5, and in the instruction decoder 1104 as indicated by icon 6. It is worth noting that at positions 3, 4, 5, or 6 only instructions (no data) are received. If the labyrinth circuitry is added at any one of these locations, the decoder block, such as decoder block 408 of FIGS. 4 and 6, can be enabled continuously, irrespective of the instruction/data and read/write lines.

The circuitry and/or various functionality of the present invention can be located at any one or any combination of these locations within a given processor 1100 while remaining true to the spirit and purpose of the invention. The spirit of the invention is present whenever instructions and data are stored in memory such that either instructions or data or both are encoded in such a way that data cannot be transparently read as executable instructions; plus the invention includes a decoder that restores transformed instructions or data, or both, as each instruction or chunk of data, or both, are read from memory.

Those skilled in the art will appreciate that at least some processors include a plurality of instruction decoder 1104. Accordingly, (while not shown) as an alternative to providing a labyrinth circuitry separate to an instruction decoder 1104, one or more instruction decoders 1104 could be particularly configured to process transformed instructions as part of its decoding functionality. However, this is viewed as being the logical equivalent of including a labyrinth circuitry within an instruction decoder 1104, as illustrated by icon 6, and is therefore anticipated as falling within the scope of the present invention.

It should be appreciated that the exemplary processor 1100 has been simplified in order to illustrate various locations in which the labyrinth circuitry may be placed, and an actual processor would typically include numerous other components not currently shown. One such component is a memory cache. In processors with one or more memory caches, it is simpler to not locate the labyrinth circuitry between a cache and memory 104, as cache consistency issues are thereby avoided. However, the present invention is not so limited. If the labyrinth circuitry is logically located between a cache and memory 104, care should be taken to ensure that stale cached instructions are refetched at appropriate times such that they are restored correctly.

While the above description has been generally made in regard to a software application loader 114 and a hardware implementation of labyrinth circuitry, it should be appreciated that the general principles may be equally and beneficially applied to a software implemented process and/or an application interpreter such as a virtual machine. In these embodiments, the steps of fetching an encoded instruction, decoding that instruction, and executing instructions should be implemented in software.

While illustrative embodiments have been illustrated and described, it will be appreciated that various changes can be made therein without departing from the spirit and scope of the invention.

1. A method to execute instructions stored in a transformed state in a memory, the method comprising:
as part of fetching a value from memory, restoring the value according to a context and a restore function if the fetch is for an instruction;
passing the restored value on for execution.

2. The method of claim 1, wherein the context is used to determine a key value for restoring the fetched value.

3. The method of claim 2, wherein the context is determined, at least in part, according to a current execution state.

4. The method of claim 2, wherein the context comprises, at least in part, any one of a random number, a pseudo-random number, a serial number, a process number, a device-assigned number, a nonce, a virtual machine ID, a security token, a hard to guess number, or any combination thereof.

5. The method of claim 2, wherein the restore function is a logical XOR operation performed on the fetched value with the key value.

6. The method of claim 2, wherein the restore function is an S-box function.

7. The method of claim 2, wherein the restore function is a Feistel network.

8. The method of claim 2, wherein the context is determined, at least in part, according to the memory address of the fetched instruction.

9. The method of claim 1, wherein instructions are stored in memory as transformed instructions according to a transform function iₜ=Transform(i, c), where i represents an original instruction, iₜ represents the corresponding transformed instruction, and c represents the context, where at least some of the context is used by the transform function; and
wherein restoring the fetched value using a restore function if the fetch is for an instruction comprises restoring the fetched value using a restore function Restore that satisfies the equation i=Restore(Transform(i, c), c).

10. The method of claim 1 further comprising, if the fetch is not for an instruction, providing an identity context to the restore function and applying the restore function to the fetched value, wherein the identity context is configured such that it satisfies the equation d=Restore(d, ic), where d represents the fetched value, Restore represents the restore function, and ic represents the identity context.

11. A method to execute an application on a computing device, the method comprising:
loading the application into a memory for execution and selectively transforming the instructions of the loaded application according to a transform function and a context; and
as a transformed instruction is fetched from the memory for execution:
restoring the fetched instruction using a restoration function and the context; and
passing the restored instruction to the next stage of execution.

12. The method of claim 11, wherein the context comprises, at least in part, any one of a random number, a pseudo-random number, a serial number, a process number, a device-assigned number, a nonce, a virtual machine ID, a security token, a hard to guess number, or any combination thereof.

13. The method of claim 11 further comprising determining a key value from the context, and wherein restoring the fetched instruction using a restore function and the context comprises restoring the fetched instruction using the restore function and the key value.

14. The method of claim 13, wherein the context is determined, at least in part, according to a current execution state.

15. The method of claim 13, wherein the context is determined, at least in part, according to the memory address of the fetched instruction.

16. The method of claim 13, wherein the restoration function is a logical XOR operation performed on the fetched instruction with the key value.

17. The method of claim 13, wherein the restoration function is an S-box function.

18. The method of claim 13, wherein the restoration function is a Feistel network.

19. The method of claim 11 further comprising, as a non-transformed instruction is fetched, providing an identity context to the restore function and applying the restore function to the non-transformed instruction, wherein the identity context is configured such that it satisfies the equation d=Restore(d, ic), where d represents the fetched non-transformed instruction, Restore represents the restore function, and ic represents the identity context.

20. The method of claim 11, wherein the transformed instructions stored in the memory are encoded according to a transform function iₜ=Transform(i, c), where i represents the original instruction, iₜ represents the transformed instruction, and c represents a context, some of which is used by the transform function; and
wherein restoring that information identified by a processor as a transformed instruction using a restore function comprises restoring the fetched instruction using a restore function Restore that satisfies the equation i=Restore(Transform(i, c), c).

21. A computing device for executing instructions stored in a memory, the computing device comprising:
a processor; and
a restoration means logically located on a data path between the processor's instruction decoder and a memory, wherein the restoration means is configured to, upon a fetch of a value from the memory:
selectively restore the value using a context and a restore function if the fetch is for an instruction; and
pass the restored instruction to the next stage of the processor for execution.

22. The computing device of claim 21, wherein the context comprises, at least in part, any one of a random number, a pseudo-random number, a serial number, a process number, a device-assigned number, a nonce, a virtual machine ID, a security token, a hard to guess number, or any combination thereof.

23. The computing device of claim 21, wherein the restoration means is logically located on the data path where only instructions are carried, such that the restoration means restores all fetched values using a context and a restore function.

24. The computing device of claim 21 further comprising a determination means for determining whether the fetch is for an instruction, and wherein the restoration means determines that the fetch is for a transformed instruction according to the determination means.

25. The computing device of claim 24, wherein the restoration means comprises a key unit providing a key value based on the context for restoring the transformed instructions, and upon a fetch of a transformed instruction from the memory, the restoration means obtains the key value for restoring the transformed instruction from the key unit.

26. The computing device of claim 25, wherein the key unit selectively provides the key value or an identity key value depending upon whether the determination means indicates that the fetch is for an instruction or data, and wherein the identity key value is configured such that it satisfies the equation d=Restore(d, ikv), where d represents the fetched data, Restore represents the restore function, and ikv represents the identity key value.

27. The computing device of claim 26, wherein the restore function is an XOR operation with the key value, and wherein the identity key value is zero.

28. The computing device of claim 26, wherein the restore function is an S-box operation.

29. The computing device of claim 26, wherein the restore function is a Feistel network.

30. The computing device of claim 21, wherein the context is determined, at least in part, according to the current state of the processor.

31. The computing device of claim 21, wherein the context is determined, at least in part, according to the memory address of the fetched value.

32. The computing device of claim 21, wherein the computing device comprises a field programmable gate array (FPGA) and wherein the restoration means is configured as a drop-in module in for the FPGA.

33. The computing device of claim 21, wherein the computing device comprises an application specific integrated circuit (ASIC) and wherein the restoration means is configured as a drop-in module for the ASIC.
